(19) United States
(12) Patent Application Publication
(10) Pub. No.: US 2025/0343961 A1
(43) Pub. Date: Nov. 6, 2025

(54) Method And System For Providing A Synchronized Shared Viewing Experience

(71) Applicant: BigUp, Inc., Brooklyn, NY (US)

(72) Inventors: Arjun Varman Balasingam, New York, NY (US); Thomas Cooper Mullen, Brooklyn, NY (US)

(21) Appl. No.: 19/198,696

(22) Filed: May 5, 2025

Related U.S. Application Data
(60) Provisional application No. 63/643,079, filed on May 6, 2024.

(51) Int. Cl. H04N 21/43; G06V 30/10

(52) U.S. Cl. CPC H04N 21/4307; G06V 30/10

(57) ABSTRACT

A system and method for synchronizing a host and client devices comprise establishing a co-watching session at a host device associated with a video signal having a time clock therein, communicating a time clock time to a system server, determining a playback offset from a plurality of content providers for the video signal, joining the co-watching session at a first client device, independently receiving a first video signal associated with a first content provider of the plurality of content providers at the first client device not through the co-watching session, and synchronizing, at the first client device, the co-watching session and playback of the first video signal with the host device based on the playback offset associated with the first content provider and the time clock time.

### CROSS-REFERENCE TO RELATED APPLICATION

This application claims the benefit of U.S. Provisional Application No. 63/643,079, filed on May 6, 2024. The entire disclosure of the above application is incorporated herein by reference.

### FIELD

The present disclosure relates to video content, and, more particularly, to a system and method for synchronizing presentation of video content and associated data from different sources to a plurality of client devices.

### BACKGROUND

This section provides background information related to the present disclosure which is not necessarily prior art.

Watching a video content with others allows a shared experience with a group. In the past, people would gather in a single spot such as a home or restaurant with friends to enjoy a particular content such as a sporting event. Broadcasted events happen at various times. However, recreating the shared experience across a wider geographic area is desirable.

Currently co-watching from centralized content providers who can directly control delivery of content is known. Netflix® and Twitch® have watch parties that provide a single piece of content that users can watch simultaneously.

There are challenges to co-watching in that some events are broadcasted by different content providers in different locations of the world. Different content providers may have slightly different timings and throughput delays especially when commercial breaks interrupt a broadcast.

### SUMMARY

This section provides a general summary of the disclosure, and is not a comprehensive disclosure of its full scope or all of its features.

The present system allows people distributed around the world to watch the same content together synchronously regardless of graphics, commentators, advertisement breaks, and the like. The present system includes controls to synchronize media elements arriving from different media source and a system to synchronize host and clients against host's clock with a browser extension.

Method to set host's clock automatically with browser extension A client-side browser extension serves as a messaging bus between browser window tabs to scrub third-party video content. An API-based scrubbing of embedded third-party video content is provided. The system computes timestamp offsets to align the same video content served by different media providers. An artificial intelligence (AI) model is used to automatically align same content from different media providers. Synchronization is also provided for other kinds of data, including but not limited to scoreboards, and chat windows. Further areas of applicability will become apparent from the description provided herein.

In one aspect of the disclosure, a method for synchronizing a host and client devices comprise establishing a co-watching session at a host device associated with a video signal having a time clock therein, communicating a time clock time to a system server, determining a playback offset from a plurality of content providers for the video signal, joining the co-watching session at a first client device, independently receiving a first video signal associated with a first content provider of the plurality of content providers at the first client device not through the co-watching session, and synchronizing, at the first client device, the co-watching session and playback of the first video signal with the host device based on the playback offset associated with the first content provider and the time clock time.

In another aspect of the disclosure, a system includes a system server and a host device that establishes a co-watching session associated with a video signal having a time clock therein and communicates a time clock time to the system server. The system server determines a playback offset from a plurality of content providers for the video signal. A first client device joins the co-watching session and independently receiving a first video signal associated with a first content provider of the plurality of content providers not through the co-watching session. The first client device synchronizes the co-watching session and playback of the first video signal with the host device based on a playback offset associated with the first content provider and the time clock time.

The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a high level block diagrammatic view of the co-watching session.

FIG. 2A is a high level block diagrammatic view of the host device of FIG. 1.

FIG. 2B is a flowchart of a method of operating the host device.

FIG. 3A is a block diagrammatic view of the client device.

FIG. 3B is a flowchart of a method for operating the client device.

FIG. 4A is a block diagrammatic view of a system server.

FIG. 4B is a flowchart of a method for operating the system server.

FIG. 5 is a screen display illustrating a watchalong session.

FIG. 6A is a screen display for creating an account within the system.

FIG. 6B is a home page for the service.

FIG. 6C is a creation page for a watchalong session.

FIG. 6D is a host page for creating a watchalong session.

FIG. 6E is a user display with an integrated video session therein.

FIG. 6F is a screen display showing two tabs opened for display of a user in which the video is completely separated from the co-watching session.

Corresponding reference numerals indicate corresponding parts throughout the several views of the drawings.

### DETAILED DESCRIPTION

Example embodiments will now be described more fully with reference to the accompanying drawings.

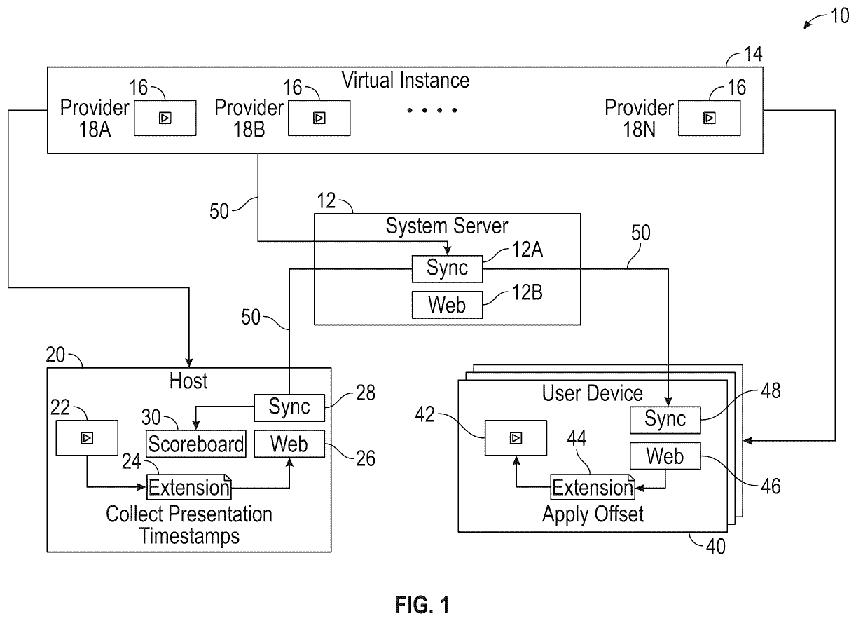

Referring now to FIG. 1, a system 10 for providing a synchronized co-watching session service is provided. One or more co-watching sessions may be serviced by a system server 12 having a synchronization (sync) service 12A and a web service 12B. The following description is set forth to one co-watching session. The system server 12 has access to virtual instances 14 of broadcasted video streams 16 from different providers 18A-18N. The video streams 16 are generally the same underlying content such as a sporting event and may be presented live. However, commercial breaks and advertisements may be inserted at a local level so that portion may be different. Due to differences in processing equipment at each provider, feed delays and the like, slight offsets may be present in the streams which could cause differences at the co-watching session even through each stream is a live stream. Alignment of the scores, commentaries and the like are removed by the present system 10. The system server 12 determines offsets of each for the video streams 16 as compared to a reference stream so that all users experience the co-watching session and its components simultaneously.

A host device 20, in general, establishes the co-watching session in communication with the system server 12 based on a video stream received at a network interface 22. An extension 24 may collect presentation timestamps that are communicated through the web page 26. The timestamps are used in the synchronization process. A synchronization system 28 may be provided at the host device 20 for synchronizing the system 10 according to a scoreboard 30. The host device 20 may be a server, a mobile device, a desk top computer or combinations thereof. Further details of the host device 20 are provided below.

Client devices 40 join a session and apply a playback offset based on the provider communicating content to the particular client. As mentioned above, client devices 40 maybe located at different places around the world and therefore different content providers 18A-18D may be providing the same content to different client devices 40. Scrubbing is the process for moving playback time forward or backward. The client device 40 determine playback offset and the game time clock time to perform the scrubbing. The client device 40 has a network interface 42 and an extension 44 that is in communication with a web page 46. The extension 44 may apply the offset find the video stream being played back with that of the host device 20 and other users. The client device may run the watchalong and provider/broadcast in the same browser session (this could be different windows or tabs). A sync module 48 obtains the scoreboard and sync offset for the providers 18 from the system server 12.

The system 10 communicates through a network 50. The network 50 may be the Internet or other types of communication systems. The network 50 communicates between the virtual instances 14 the server 12, the host devices 20 and the client devices 40.

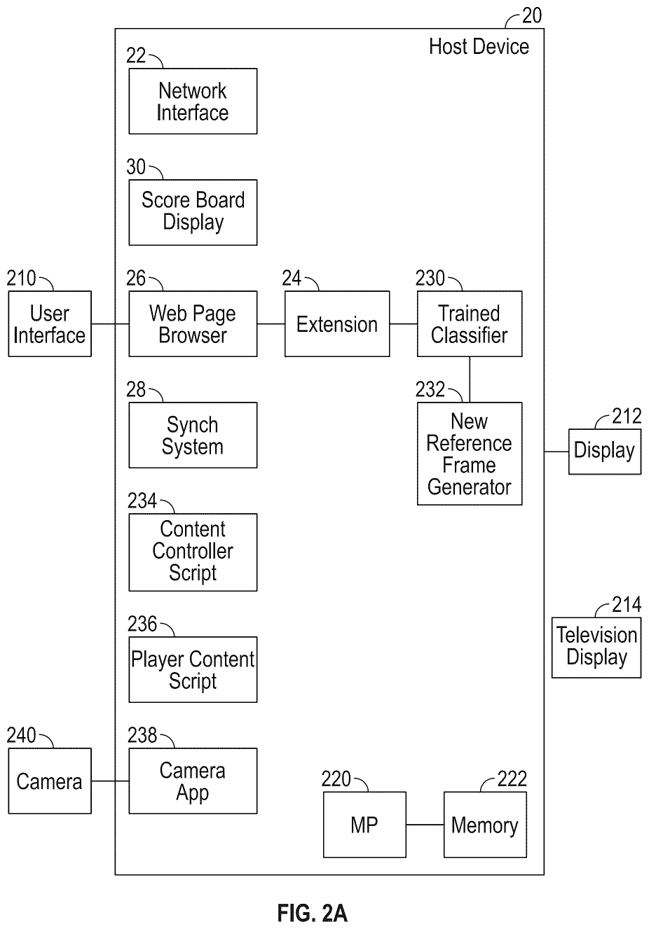

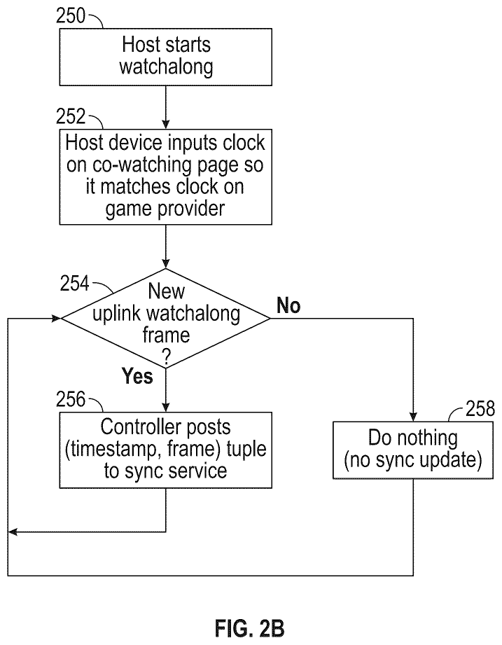

Referring now to FIG. 2A, a host device 20 is illustrated in further detail. The host device 20 has a user interface 210 associated therewith. The user interface 210 may include a keyboard, a mouse or another type of interface device. The user interface 210 may also include a touch screen display such as display 212. The display 212 does not have to be a touch screen. In any case, the illustrated display 212 is used for displaying the co-watching session and the controls required by the host device 20 to generate the co-watching session. For example, the host device 20 may have a first web page (browser tab) for controlling the co-watching session and a second webpage (browser tab) for displaying the stream. The host device 20 may have two browser windows (or tabs) open. One window displays the co-watching session livestream, served by the co-watching session platform. The other window displays the live game footage, served by the third-party game provider to which the host subscribes. However, in other circumstances, the host device 20 may not have a stream being received. Rather, the host may be watching the game or event on a separate screen or television display 214 not electrically connected with the host device 20.

The host device 20 may be microprocessor based. The microprocessor or processor 220 is illustrated in communication with a memory 222. The memory 222 may be a non-transitory computer-readable medium including machine-readable instructions that are executable by the processor 220. The machine-readable instructions include instructions for generating the co-watching session and the like. The memory 222 may be used as a buffer for storing video and various other data and operating settings of the co-watching session.

The host device 40 may also include a camera application 238 coupled to a camera 240. The co-watching session may include a camera display generated by the camera 240 that includes audio and video. It should be noted that multiple host device may form the co-watching session and therefore multiple video windows may be present from each device within the co-watching session. However, one is chosen as the master host in terms of synchronization.

Referring now also to FIG. 2B, the method for a co-watching session (watchalongs) is set forth. In step 250, a watchalong host starts a co-watching session. This may be performed using the user interface 210 of the host device 20. In step 252, the host device inputs a clock on the co-watching page so it matches the clock on the gain provider. This may be performed manually or automatically using the extension 24. As mentioned above, the extension 24 may obtain the game clock using a trained classifier 230 that uses optical recognition for a screen display. Ultimately, the game clock at the host device is communicated through the network 50 to the system server 12. The trained classifier 230 may correlate with game provider's page which extracts presentation timestamps for each video frame of the game footage and a content controller script on the co-watching session page which receives the presentation timestamps for each frame of the game and correlates it with the outbound co-watching session frame. A tuple may be formed having a presentation timestamp and a frame identifier that is communicated to the system server 12. This may be performed once at the beginning of the game or periodically as will be described in greater detail below.

In step 254, a new uplink watchalong frame may be determined. The new uplink watchalong frame may be determined using the trained classifier 230. For example, when a commercial break or other type of interruption in the video screen for which the game clock is no longer displayed, the system may trigger a new uplink watchalong frame or reference frame be generated and a tuple created to ensure the other devices, such as the client devices, stay in-sync with the host device. In step 254, when a new uplink frame has been generated, step 256 posts a tuple of a new timestamp and frame number to the sync service 12A within the system server 12. In step 254, when no new uplink watchalong frame has been identified, step 258 does nothing. The system continually monitors whether a new uplink watchalong frame has been generated.

In summary, for outbound co-watching session frames, a content controller script 234 sends a query to the player content script 236 for a presentation timestamp. Upon receipt, the controller 220 communicated the tuple (presentation timestamp, frame ID) to the sync service 12A. This repeats indefinitely until the co-watching session concludes.

The player content script 236 may be used to populate the chat window with data, the layout of the device and for displaying a score on the screen. A description of the co-watching display is set forth below.

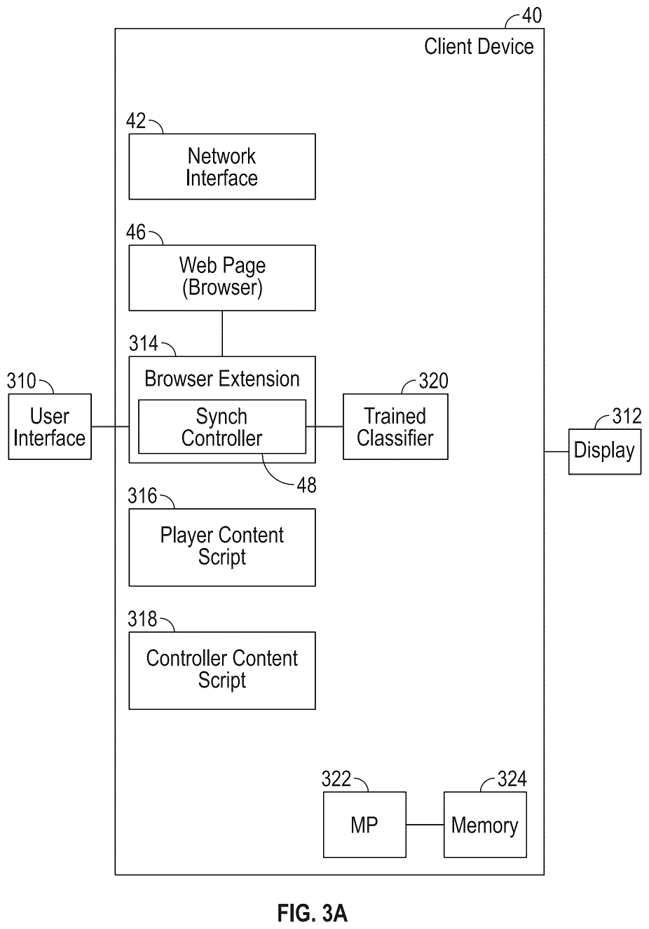

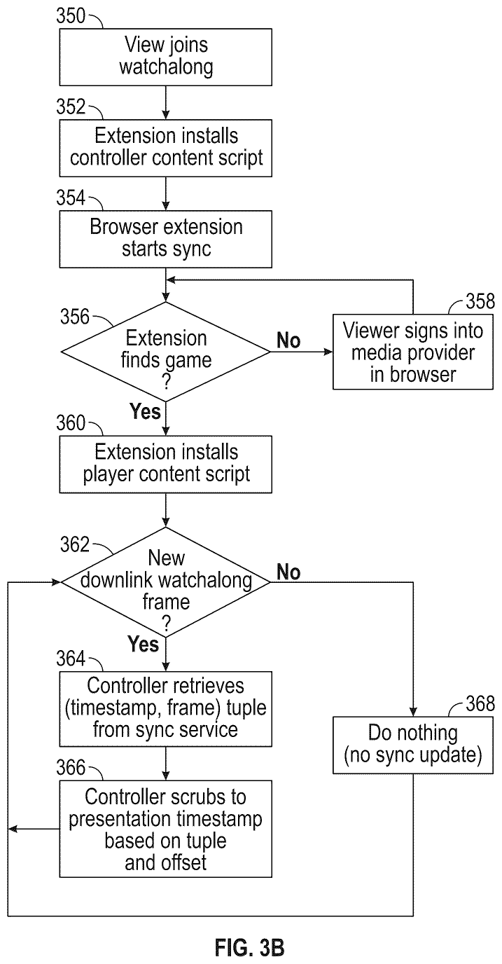

Referring now to FIG. 3, the client device 40 is illustrated in further detail. The client device 40 has a user interface 310 which may be configured as described above. A display 312 may also be provided. The display 312 may display one or more tabs of a web browser as will be described in greater detail below. The network interface 42 is used for interfacing through the network 50 as described above. The network 50 may provide various data including the score board synchronization offset. As well, the client device 40 may communicate data to the system server such as authentication data and the like. A browser extension 314 may install a sync controller 48. The sync controller synchronizes the displaying of the co-watching session on the display 312 so that it is synchronized with the other users including the host device. A player content script 316 is used for displaying the content player as well as watching the received data for a new downlink watchalong frame that is communicated from the system server 12. The player content script 316 may also be used to control the content being displayed in two different tabs of the display 312. The player content script 316 may also be used to control the content being displayed in two different tabs of the display 312. The player content script 316 may also be used for scrubbing the video. A controller content script 318 may also be installed on the system.

Referring FIG. 3B a viewer joins a co-watching or watchalong session. In this example, the viewer may select a host. In a sports situation, the host may be biased for one team or the other so that a viewer can be in a like-minded session.

A co-watching session viewer has two browser windows (or tabs) open. One window displays the co-watching session video player, served by the co-watching session platform. The other window displays the live game footage, served by the third-party content provider to which the viewer subscribes.

After the host goes live with the co-watching session, the browser extension script on each browser window facilitates messages between both pages.

In step 352, the content controller script 318 on the co-watching session page receives the tuple (presentation timestamp, frame ID) from the sync service 12A through the network 50 for each downlink video frame or other reference frame that is displayed by the video player.

In step 354, the browser extension starts the synchronization through the sync controller 58. The synchronization uses the game time clock time from the host device and the playback offset determined for each of the different content providers as mentioned above. Step 356 determines whether the client device finds the game or other streaming content within the browser window. The sync controller 48 presumes that games that are opened in a tab are the game being watched. If the extension does not find a game, step 358 may allow the viewer to sign into a content provider within the browser using the user interface 310. In summary, the extension either (i) automatically finds already open content hosted on any whitelisted URLs or (ii) prompts the user to indicate which window/tab has the content.

When the extension finds a game, step 356 is answered in the affirmative and step 360 is performed. It should be noted that the first video signal that is associated with the content being streamed is received independent of the co-watching session. The co-watching session may have various video chat and live video from a host but the game is a separate stream that is received directly from the content provider. However, the client device can monitor and control the playback by allowing the sync controller 48 to scrub in a forward or rearward direction. That is, the first video signal is independently received separate from the co-watching session data. The player content script on the content provider's page is used for scrubbing the video player on the game feed to a separate timestamp offset that is determined as mentioned above based upon the playback offset and the time clock time that the host device is at for the playback. This is performed in step 360. To perform the synchronization, along with each inbound co-watching session frame, the content controller script receives the associated (presentation timestamp, frame ID) offset from the sync service. Upon receipt, the controller sends a command to the player content script running on the game feed window to scrub the player to the specific presentation timestamp. This may repeat indefinitely until the co-watching session concludes. In practice, however, resyncs may be triggered whenever the client drifts from the host, e.g., due to network outages or ad breaks. If a client drifts, then that client's experience is adjusted accordingly. If the host drifts, then all clients are adjusted accordingly. Under this model, all participants in the watchalong are bottlenecked by the host.

At the host and at the client device the times are converted to the universal Unix time. At the host, the unixProgramStartTime=((UnixEpochTimeGivenHostClock)−currentPresentationTime), is sent, then the presentation time to seek to at the client device is computed using currentPresentationTime=(UnixEpochTimeGivenReconstructedHostClock−unixProgramStartTime), where the reconstructed host clock is the viewer's clock plus an offset computed by the timestamps embedded into each “frame” of the incoming co-watching session video. This method is used because presentation timestamps would be completely out of date by the time they arrived at the viewer due to networking delay.

After the synchronization takes place, step 362 is performed. In step 362 if a new downlink watchalong frame is received (this may be referred to as a reference frame), the controller receives the timestamp and frame (tuple) from the synchronization service 12A in step 364. In step 366, the controller scrubs the system to the presentation timestamp provided from the host 20. In step 362, when no new downlink watchalong frame is provided, step 368 does nothing so that the synchronization is not manipulated. It should be noted that determining whether a new downlink watchalong frame has been generated may be performed at the host device and communicated to the client. That is, when an advertisement or another type of video signal interruption takes place, the new downlink watchalong frame may be generated. However, the client device 40 may also be associated with a trained classifier 320. The trained classifier may recognize interruptions in the display of the video stream for various causes such as an interruption in the internet service and based on that resynchronize the system for both the co-watching session and the video presentation. The system may also include a microprocessor or processor 322 that is in communication with a memory 324. The memory may be a non-transitory computer-readable medium that has instructions for operating the processor 322. The memory may also store various intermediate data values processed during the operation of the client device 40.

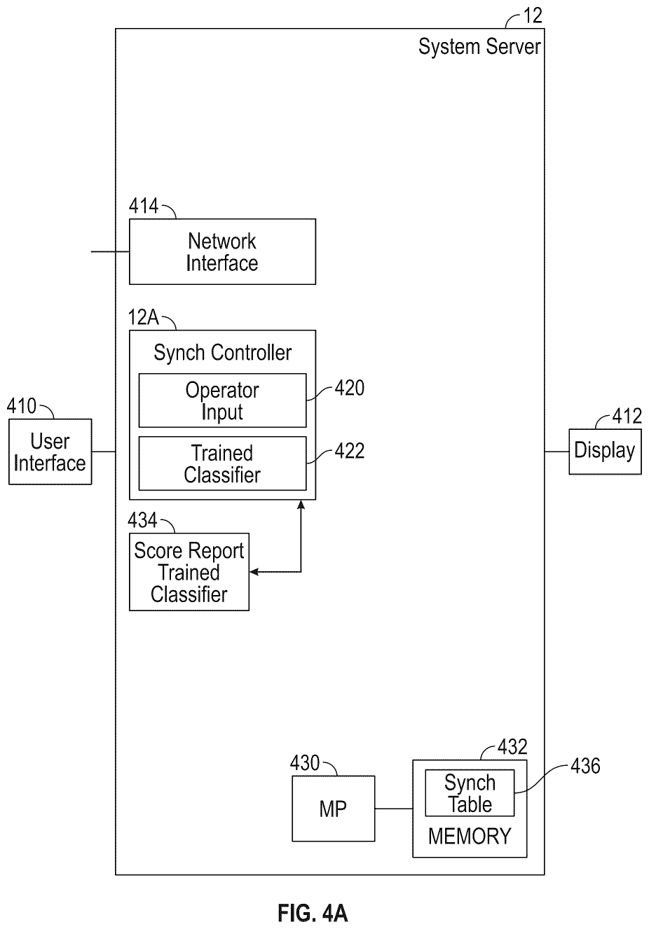

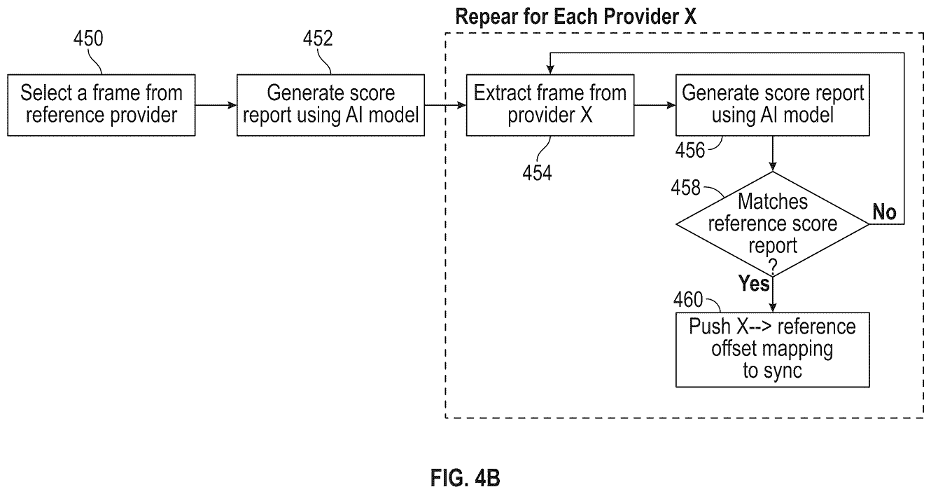

Referring now to FIGS. 4A and 4B, the operation of the system server 12 is set forth along with a block diagrammatic view of the system server. The system server 12 may include a user interface 410 and a display 412 in a similar manner to those described above. In this case, the user interface 410 may allow an operator to perform synchronization of the signals from the various content providers 18A-18N. Also, a network interface 414 for interfacing with the network 50 is provided. The synchronization controller may receive operator input 420 to perform the synchronization. As well, a trained classifier 422 may also be used to perform the synchronization between the various providers 18A-18N. The system server 12 may also be microprocessor based and therefore a processor 430 and a memory 432 may be provided in the system server 12. The memory may be a non-transitory computer-readable medium including machine-readable instructions that processed by the processor 430 to perform various functions including offsets at the synchronization controller 12A.

Referring now specifically to FIG. 4B, step 450 allows the operator or the trained classifier 422 to select a frame from a reference provider which is one of the providers 18A-18N illustrated above. A score report trained classifier 434 of the system server may be used to generate a score report in step 452. That is, an AI-based or a trained classifier may be used to obtain a score report using optical character recognition and the trained classifier. A frame may be captured that has a scoreboard thereon to determine the game time clock time set forth therein. For each of the providers, a frame from a different provider is obtained in step 454. A score report is generated using the score report trained classifier 434 in step 456. When the reference score report from step 452 is compared to the score report in step 456, it is determined whether there is a match in step 458. If there is not a match, step 454 provides another extraction of a frame. However, in step 458, if there is a match, the reference offset is provided to the sync service and stored within the memory 432. The memory 432 may save a sync table 436 with all of the offsets from all of the providers in step 460.

To summarize, assume there are N content providers, where one is designated as the reference provider R. For each provider X≠R, a timestamp offset is computed that maps unique frames in X to frames in R. The sync service 12A applies the timestamp offset for each respective provider to the presentation timestamp before each tuple to the viewer.

In the alternative, the presentation times may also be extracted from all providers and all the times are sent to the client, then the client computes relative offset based off host provider (as reference) and client provider (determined by extension polling of 3rd party page.

When the offset uses operator input 420, a GUI tool that allows an operator to view the feed for each provider to sync and align their scrub states so that they point to the same point in the game. Once aligned, the operator clicks “sync”, and the tool captures the presentation timestamps and builds a lookup table of timestamp offsets to send to the sync service.

As mentioned above an Al tool, the score report trained classifier 422, may be used to automate alignment. By way of example, for each content provider, the last frame of time 00:00 is searched. So, in 1 frame increments, sampling is used to find the transition between 00:00 and 00:01. Then frames are searched within the transition window to find the last frame in which the game time was 00:00. The score report trained classifier is built to extract the game clock time from a video frame. Once the correct frame is identified, the timestamp offset relative to the reference provider is computed, build a lookup table, and push it to the sync service.

Alternatively, advertisement breaks, interruptions, removal of the game clock or common events may be used rather than a game clock transition.

In one implementation, the browser extension simply serves as a messaging bus between the co-watching session page and a third-party page hosting video content that needs to be synchronized with the co-watching session.

The sync procedure described above can run every frame, though in practice a coarser interval is run since offsets should be (relatively) constant. Offsets can change when feeds are interrupted with ad breaks, when a network outage occurs, during halftime shows, etc.

Other mechanisms may be used to synchronize third-party content in different realizations of the system. All of these methods use the same control algorithm to sync videos at the client-side.

If the viewer is watching on an external device (e.g., TV or tablet), a mobile app is used to record a snippet of the game feed and upload it to the sync service, which determines the current game time, and ensures that the co-watching session content is synchronized to it.

If same host/viewer sync algorithms described above can be adapted to a slightly different architecture, where the game feed is embedded into the co-watching session platform. In that case, instead of a browser extension that communicates between windows, API calls are made to the player directly to (i) extract presentation timestamps from the host's game feed and (ii) scrub presentation time on the viewer's game feed.

If third-party content is embedded as a video player, the sync system leverages API access to the video player to scrub playback according to offsets computed by the control algorithm.

If third-party content resides in a different browser tab/window, the system has a client-side browser extension with a messaging system to convey timestamp offsets and scrub playback by injecting a Javascript snippet.

An easy-to-maintain, flexible and robust extension that allows synchronization between video and data content and arbitrary 3rd-party video content.

An extension that acts as a simple proxy for the HTML VideoElement on 3rd-party pages. The extension does not contain any state-management or synchronization logic and only serves to proxy some basic RPC calls between the main Tifo web app and the 3rd-party page.

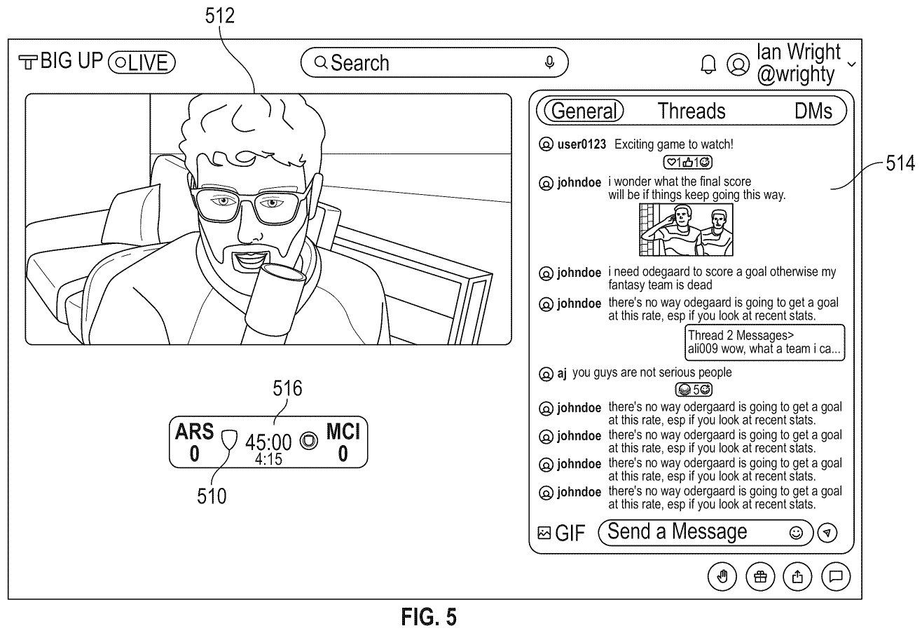

Referring now to FIG. 5, a co-watching session is illustrated. The session has a score area 510, a host display area 512 and a chat area 514. The chat area 514 includes user commentary and host commentary. A game or time clock 516 within the score area 510 may be used to synchronize other user as the time clock time mentioned above. The host may control the chat area 514.

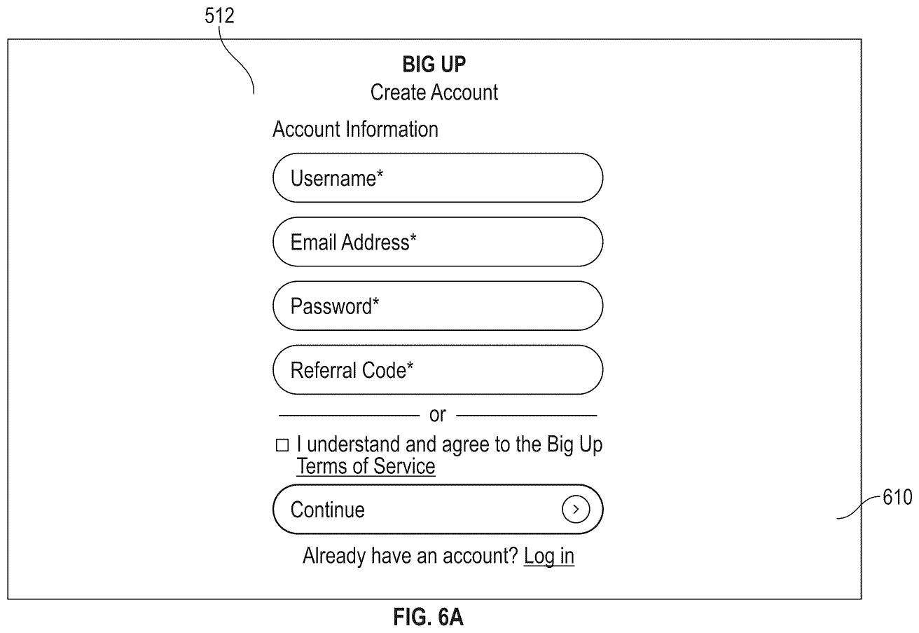

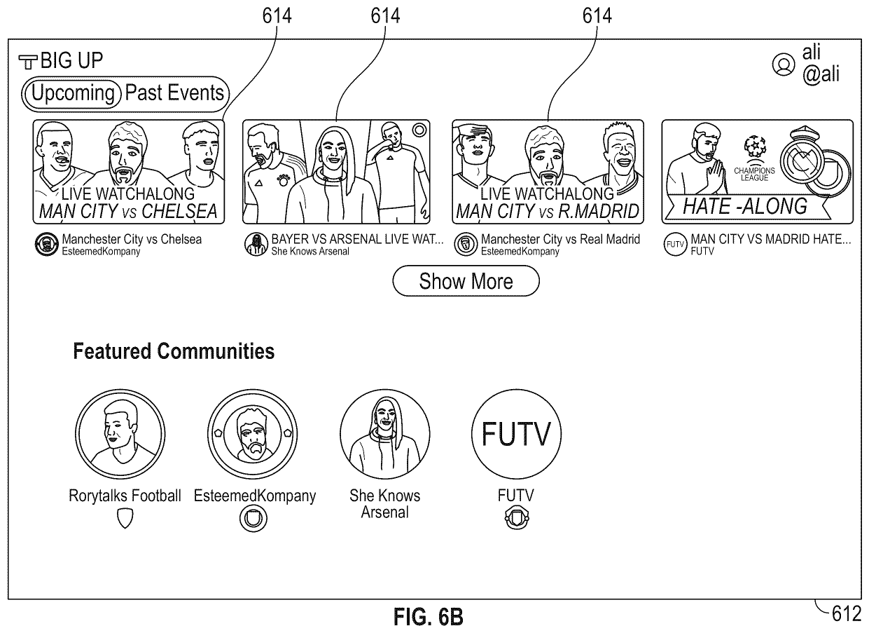

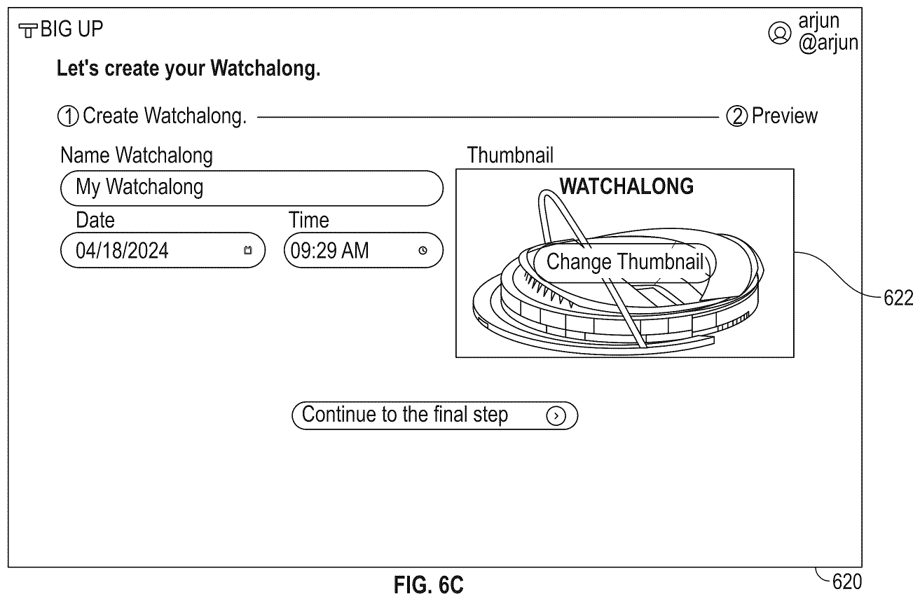

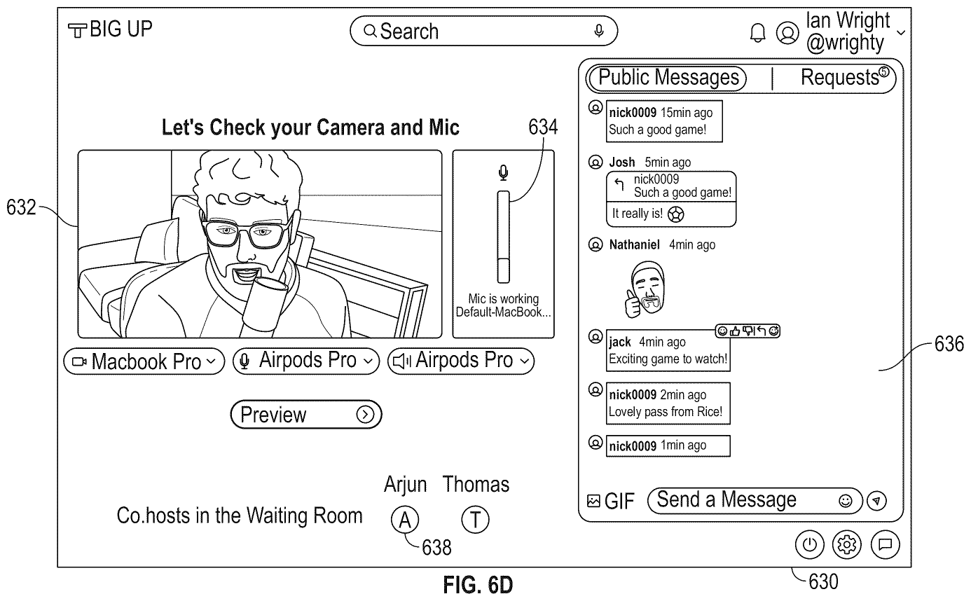

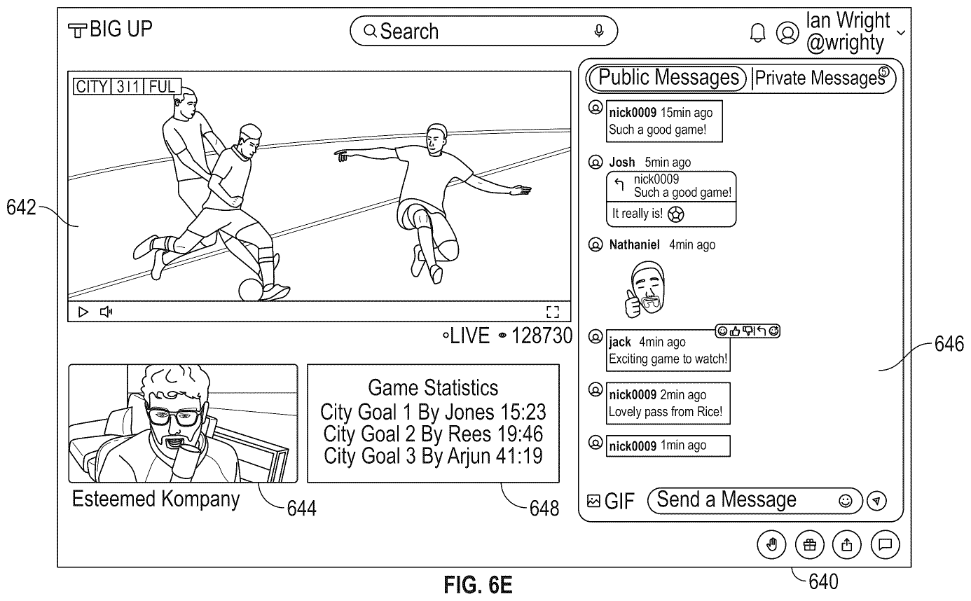

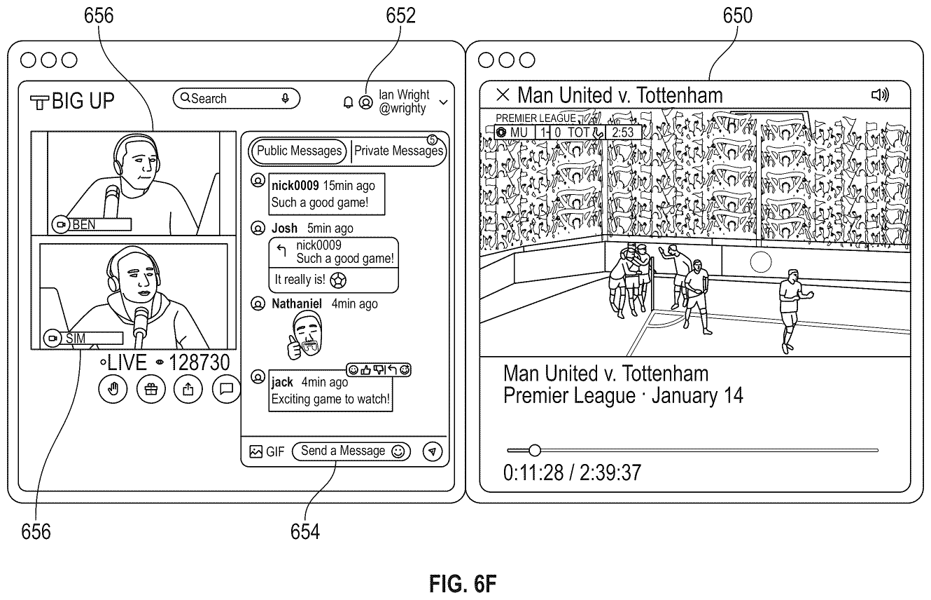

Referring now to FIG. 6A, a screen display for creating an account is set forth in which user information, such as a username, password and the like may be entered. In FIG. 6B, a home page 612 has a plurality of watchalong events 614 illustrated thereon. The user may select a watchalong session from the plurality of watchalong events 614. In FIG. 6C, a screen display 620 is used for creating a watchalong session and includes a place for inserting a name, date and the like. A thumbnail display 622 may be used for creating a thumbnail for display at the home page 612. In FIG. 6D, a screen display 630 for the watchalong host may allow various controls to be displayed for the host. A camera display 632, a microphone display 634 and a chat display 636 may all be provided. A preview and a user interface 638 for allowing cohosts to join are set forth.

In FIG. 6E, a screen display 640 for a watchalong session is provided to allow a user to join a watchalong session. Once joined, a video screen display 642 is provided along with a video screen of the host 644 and the chat window 646. The video display area 642 may be integrated into the screen display even though provided independently from the content provider. A game statistic area 648 may be set forth with various game statistics such as goals scored in this example. The display may be generated synchronously with the time clock time so that data is not presented before the particular co-watching session is at that particular time in terms of display.

Referring now to FIG. 6F, a video display area 650 is in a separate tab from the co-watching session 652. The co-watching session 652 includes the chat area 654 and the host area 656. In this example two host video displays are provided in the host area 656. However, as mentioned above, the extension may allow the playback of the video area 650 and the stream contained therein to be synchronized with the co-watching session.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
establishing a co-watching session at a host device associated with a video signal having a time clock therein;
communicating a time clock time to a system server;
determining a playback offset from a plurality of content providers for the video signal;
joining the co-watching session at a first client device;
independently receiving a first video signal associated with a first content provider of the plurality of content providers at the first client device not through the co-watching session; and
synchronizing, at the first client device, the co-watching session and playback of the first video signal with the host device based on the playback offset associated with the first content provider and the time clock time.

2. The method of claim 1 wherein establishing the co-watching session comprises setting a co-watching clock based on an extension at the host device.

3. The method of claim 1 wherein establishing the co-watching session comprises setting a co-watching clock based on a user interface signal from the host device.

4. The method of claim 1 further comprising storing the playback offset for each of the plurality of content providers in a table within a memory of the system server.

5. The method of claim 1 wherein determining the playback offset is performed periodically.

6. The method of claim 1 wherein determining the playback offset is performed using a trained classifier.

7. The method of claim 1 wherein determining the playback offset is performed by generating an optical character recognition of a score in the first video signal.

8. The method of claim 1 wherein determining the playback offset is performed based on an advertisement break in the first video signal.

9. The method of claim 1 further comprising resynchronizing the co-watching session and playback of the first video signal after an advertisement break in the first video signal.

10. The method of claim 1 further comprising resynchronizing the co-watching session and playback of the first video signal after a game clock removal or an interruption in the first video signal.

11. The method of claim 1 further comprising determining a first reference frame of the first video signal to the host device;
based on the first reference frame, generating a first reference offset at the host device;
communicating the first reference offset from the host device to the first client device;
thereafter, displaying the first video signal at the display adjusted by the first reference offset.

12. The method of claim 11 wherein the first reference frame comprises a score and wherein generating the first reference offset comprises generating the first reference offset based on the score.

13. The method of claim 1 further comprising generating game statistics at the host device, communicating the game statistics to the first client device, and displaying the game statistics based on the first content provider and the time clock time.

14. The method of claim 1 further comprising receiving comments, data, statistics, user commentary and host commentary from a plurality of users at the host device, communicating the comments to the first client device through the co-watching session and displaying a comment time adjusted by the first content provider and the time clock time.

15. A system comprising:
a system server;
a host device establishing a co-watching session associated with a video signal having a time clock therein and communicating a time clock time to the system server;
the system server determining a playback offset from a plurality of content providers for the video signal; and
a first client device joining the co-watching session and independently receiving a first video signal associated with a first content provider of the plurality of content providers not through the co-watching session, the first client device synchronizing the co-watching session and playback of the first video signal with the host device based on a playback offset associated with the first content provider and the time clock time.

16. The system of claim 15 wherein the host device comprises an extension setting a co-watching clock based on an extension or a user interface signal from the host device.

17. The system of claim 15 wherein the system sever determines the playback offset periodically.

18. The system of claim 15 wherein the system server determines the playback offset using a trained classifier.

19. The system of claim 15 wherein the system server determines the playback offset by generating an optical character recognition of a score in the first video signal.

20. The system of claim 15 wherein the system server determines playback offsets based on an advertisement break in the first video signal.
